(19) United States
(12) Patent Application Publication
(10) Pub. No.: US 2005/0139273 A1
(43) Pub. Date: Jun. 30, 2005

(54) Electromechanically controlled proportional valve

(75) Inventor: Giancarlo Morselli, Modena (IT)

Correspondence Address: YOUNG & THOMPSON, 745 SOUTH 23RD STREET, 2ND FLOOR, ARLINGTON, VA, 22202, US

(73) Assignee: TECNORD S.R.L., MODENA (IT)

(21) Appl. No.: 10/745,584

(22) Filed: Dec. 29, 2003

(51) Int. Cl. F15B 13/043

(52) U.S. Cl. 137/625.64

(57) ABSTRACT

The proportional valve is insertable in a support element and comprises a hollow body having a plurality of inlet openings, a plurality of outlet openings and a plurality of discharge openings. The hollow body further comprises a pilot channel afforded in a base surface, an end of which pilot channel can be closed by a bearing. The valve comprises an obturator which is predisposed to place in communication the inlet, outlet and discharge openings selectively. The obturator exhibits an internal channel which transmits a pressure in the inlet openings to the bearing. The hollow body is screwed to a container which houses an electromechanical actuator that acts on the bearing. The valve can be connected to the support element by means of a screw.

### BACKGROUND of the INVENTION

The invention relates to an electromechanically controlled proportional valve. In particular a preferred use of the valve is for clutch activation in transmissions for vehicles having motors that develop high-intensity torque. The valve is of a cartridge type which is insertable in a support element and connectable thereto. A mobile obturator located internally of a hollow body selectively places in communication some openings, from which a pressurized operating fluid flows, with some outlets predisposed to send the pressurized fluid to an actuator, typically a hydraulic cylinder predisposed to close the clutch which, in the absence of commands, is kept open by springs or like elements.

In known-type valves the mobile obturator exhibits a substantially axial conduit which connects the inlet openings with a pilot conduit, placing the valve in communication with a storage reservoir for the operator fluid. The outlet of the pilot conduit can be closed by means of a spherical control bearing on which an electromechanical actuator operates. The actuator, on command, presses the bearing against the pilot conduit outlet. The action of the electromechanical actuator on the control bearing leads to an increase of pressure in an internal chamber of the valve which induces a movement of the obturator towards a position in which the pressurized fluid reaches the hydraulic actuator.

In known-type valves the axial conduit of the obturator sends the pressurized oil directly onto the control bearing. The dynamic action of the oil flow makes an equilibrium position difficult to reach, in which the bearing maintains a certain position with respect to the pilot conduit outlet. Turbulence in the oil flow can lead to vibrations which compromise the precision of the valve operation.

The electromechanical actuator acts on the control bearing by means of a stem, a length of which must correspond with extreme precision to a defined value, in order to guarantee that the valve will function correctly. In known-type valves correct operation is guaranteed during a testing stage of the valves by substituting the stems with stems having different lengths, until the correct-length stem is identified. This operation is very slow and laborious, as it requires a valve which is already full of oil to be dismounted in order for the stem to be changed. This operation may need repeating several times until the correct-length stem is found.

Known-type valves also require additional components in order that they can be fixed to support elements therefor.

The main aim of the present invention is to provide an electromechanically controlled proportional valve which enables the drawbacks in the prior art to be obviated.

An advantage of the present invention is that a relatively stable pressure acts on the bearing, i.e. a pressure which is not subject to sharp fluctuations due to turbulence in the fluid; as a result the valve is extremely stable.

A further advantage of the invention is that the regulation of the stem length by which the electromechanical actuator acts on the bearing is extremely simple and rapid and does not require the valve to be dismounted.

A further advantage of the invention is that the valve can be fixed to the relative support element without additional components or mechanisms.

### SUMMARY of the INVENTION

The proportional valve is insertable in a support element and comprises a hollow body having a plurality of inlet openings, a plurality of outlet openings and a plurality of discharge openings. The hollow body further comprises a pilot channel afforded in a base surface, an end of which pilot channel can be closed by a bearing. The valve comprises an obturator which is predisposed to place in communication the inlet, outlet and discharge openings selectively. The obturator exhibits an internal channel which transmits a pressure in the inlet openings to the bearing. The hollow body is screwed to a container which houses an electromechanical actuator that acts on the bearing. The valve can be connected to the support element by means of a screw.

### BRIEF DESCRIPTION of the DRAWINGS

Further characteristics and advantages of the present invention will better emerge from the detailed description that follows of an electromechanically controlled proportional valve, illustrated purely by way of a non-limiting example in the accompanying figures of the drawings, in which:

FIG. 1 is an overall view in section of a valve according to the invention;

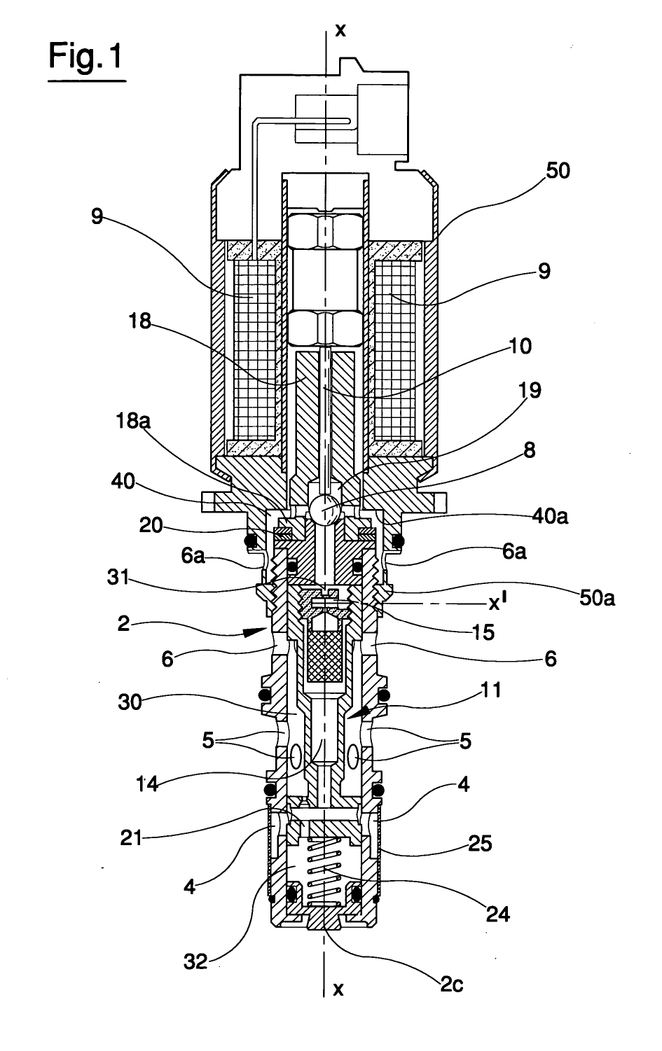

FIG. 2 is an exploded view of a part of the valve of FIG. 1;

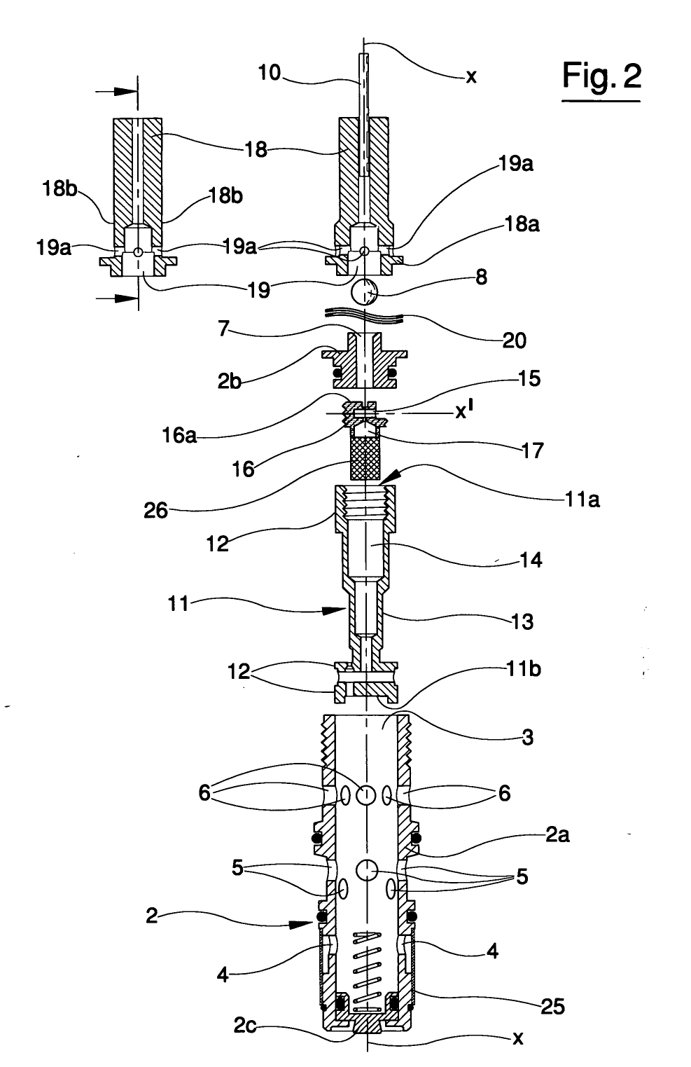

FIG. 3 is a detail of the valve of FIG. 1, installed and connected to a support element.

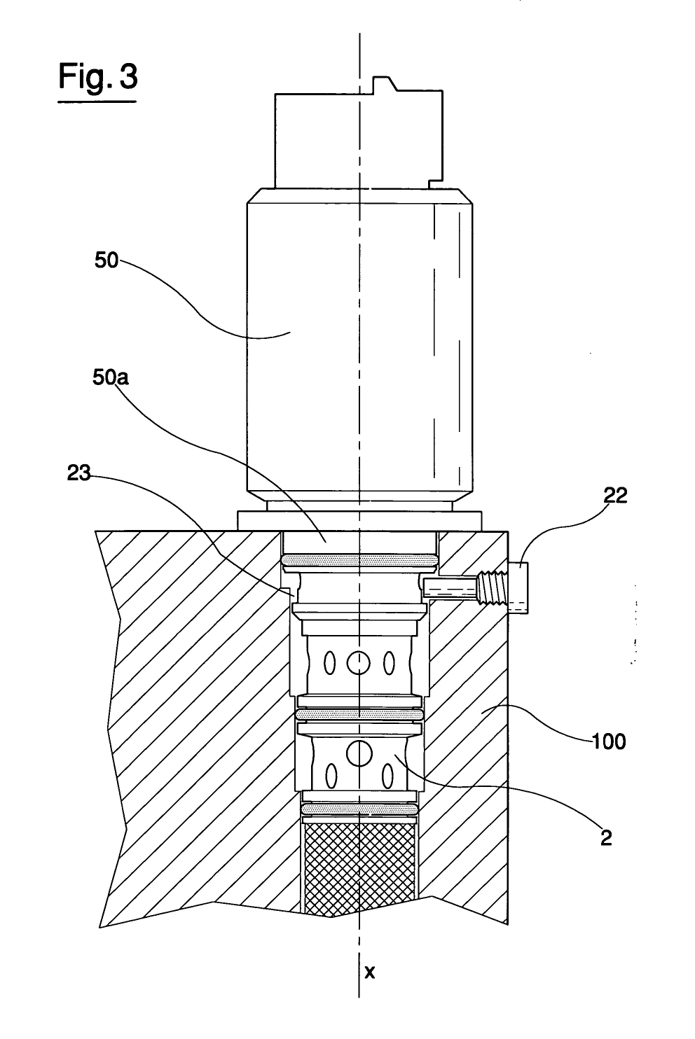

### DESCRIPTION of the PREFERRED EMBODIMENTS

With reference to the figures of the drawings, the valve of the present invention comprises a hollow body 2, cylindrical in shape and having a longitudinal axis x which comprises a lateral surface 2a, and a first and a second base surface 2b, 2c. The hollow body exhibits a cylindrical internal cavity 3 and is radially provided, on the lateral surface 2a, which a plurality of inlet openings 4, a plurality of outlet openings 5 and a plurality of discharge openings 6. The inlet openings 4 are predisposed for connecting the internal cavity 3 with a pressurized operator fluid source, for example a positive displacement pump. The outlet openings 5 are predisposed for connecting the internal cavity 3 with an actuator, for example a cylinder for closing the clutch. The discharge outlets 6 are predisposed for connecting the internal cavity 3 with a reservoir from which the operator fluid is taken by the positive displacement pump. The inlet openings 4 can be protected by a filter surface 25 enveloping the hollow body 2.

The hollow body 2 further comprises a pilot channel 7 afforded in the first base surface 2b and coaxial to the longitudinal axis x. The exit of the pilot channel 7 can be occluded by a bearing 8 which is mobile in a parallel direction to the longitudinal axis. The pilot channel 7 is predisposed to place the internal cavity 3 in communication with a discharge chamber 40, the function of which will be better clarified herein below, which discharge chamber 40 is annular and arranged coaxially to the hollow body 2. The discharge chamber 40 exhibits secondary outlet openings 6a connected to the reservoir of operator fluid.

The valve of the invention further comprises a container 50, preferably cylindrical, internally of which an electromechanical actuator 9 and a cylindrical element 18 which is coaxial to the longitudinal axis x are arranged. At an end thereof the cylindrical element 18 exhibits a cylindrical seating 19, coaxial to the longitudinal axis x, internally of which the bearing 8 can slide. The cylindrical element 18 also exhibits a through-hole, coaxial to the longitudinal axis x, along which a stem runs 10. The electromechanical actuator 9 is predisposed on command to exert on the stem 10 a force directed along the longitudinal axis x. Following the application of this force, the stem 10 pushes the bearing 8 towards the exit of the pilot channel 7.

The cylindrical seating 19 is provided with radial through-holes 19a which place the seating in communication with the discharge chamber 40. At least two of the through-holes 19a open into shaped portions 18a of the cylindrical element 18 located in a diametrically opposite position with respect to the cylindrical element 18. The shaped portions 18b are flattened areas of the lateral surface of the cylindrical element 18. The arrangement of the radial through-holes 19a induces a fluid circulation, about parallel to the longitudinal axis x, about the cylindrical element 18. From the radial through-holes 19a which open onto the shaped portions 18b the fluid tends to move in a distancing direction from the discharge chamber 40, while from the other radial through-holes 19a the fluid is directed towards the discharge chamber 40. Thanks to the fluid circulation the internal chamber in the container 50, in which the cylindrical element 18 and the cursor of the electromechanical actuator 9 are located, fills rapidly and is kept constantly full of fluid; this is a factor which increases the precision and the stability of the valve operation. The hollow body 2 is connected to the container 50 in such a way that it projects, at least for a tract thereof, internally of the container 50. The discharge chamber 40 is defined between the above-mentioned tract of the hollow body 2 and a projecting cylindrical portion 50a of the container 50. In greater detail, the hollow element 2 is screwed to the container 50, projecting inwardly of the projecting cylindrical portion 50a, which internally exhibits a threading having a mean diameter which is smaller than the internal diameter of the cylindrical portion 50a. In this way, a hollow space is created between the hollow body 2 and the cylindrical portion 50a; this hollow space defines the discharge chamber 40.

The cylindrical element 18 comprises an annular expansion 18a predisposed to rest against a striker surface 40a of the discharge chamber 40 and prevent distancing displacements of the cylindrical element 18 from the hollow body 2. Elastic means 20 are interpositioned between the cylindrical element 18 and the hollow body 2 to keep the annular expansion 18a in contact with the striker surface 40a.

The threaded connection between the hollow body 2 and the container 50, and the contact between the annular surface 18a and the striker surface 40a enable the length of the stem 10 to be adapted to the desired operating characteristics of the valve. The elastic means, for example Belleville washers, keep the cylindrical element 18 in striking position against the discharge chamber 40, so by unscrewing or screwing the hollow element 2 it is possible to vary the force the stem 10 exerts on the bearing 8 both in the presence of a command to the electromechanical actuator and in absence thereof. Once the relative positioning between the hollow element 2 and the container 50 have been defined, the two parts can be fixed by slightly deforming the edge of the projecting portion 50a at a slightly weakened point which can be afforded on the external surface of the hollow element 2.

The valve of the present invention further comprises a cylindrical obturator 11 which is sealingly slidable internally of the internal cavity 3 along the longitudinal axis x. The obturator 11 exhibits an annular channel 13 which defines, with the surface of the internal cavity 3, a communication chamber 30. The obturator 11 is mobile between a first position, in which through the communication chamber 30 it places in communication the outlet openings 5 with the discharge openings 6, and a second position, in which it places in communication, once more through the communication chamber 30, the outlet openings with the inlet openings 4.

The obturator 11 is provided with an internal channel 14 for placing the inlet openings 4 and the pilot channel 7 in communication when the obturator 11 is in the first position. A terminal tract 15 of the internal channel 14, which ends close to an inlet of the pilot channel 7, exhibits a different longitudinal axis x′ to the longitudinal axis x, so that the outlet of the terminal tract 15 does not face the inlet of the pilot channel 7.

The terminal tract 15 of the internal channel 14 is afforded internally of an end element 16 which is inserted in an end of the obturator 11 which is located by the pilot channel 7. The end element 16 comprises an inlet tract 17 which opens, through a nozzle, into the terminal tract 15. Preferably the terminal tract 15 is perpendicular to the longitudinal axis x. The inlet tract 17 of the internal channel 14 can be protected by a sleeve filter 26 connected to the end element 16.

The obturator 11 is provided at ends thereof with sealed surfaces 12, arranged in contact with the surfaces of the internal cavities 3, between which the annular channel 13 is comprised. At the position of the sealing surfaces the external diameter of the obturator 11 is close to that of the internal cavity 3 in order to prevent oil leakage along the walls of the internal cavity 3.

The obturator 11 comprises a first end surface 11a, perpendicular to the longitudinal axis x, which defines within the internal cavity 3 a first pilot chamber 31 in communication with the pilot channel 7. The first pilot channel 31 is defined by the first end surface 11a of the obturator 11, the first base surface 2b and the lateral surface 2a of the hollow element 2. In the illustrated embodiment in the figure, the first end surface 11a comprises an annular crown which surrounds a central portion 16a defined by a base surface of the end element 16. The central portion 16a is arranged in a recessed position with respect to the annular crown, so that when the obturator 11 is in the first position, the annular crown is in contact with the first base surface 2b of the hollow element 2, forming a hollow jacket between the central portion 16a and the first base surface 2b.

The obturator 11 further comprises a second end surface 11b, perpendicular to the longitudinal axis x, which inside the internal cavity 3 defines a second pilot chamber 32, arranged on an opposite side of the obturator 11 to the first pilot chamber 31. The second pilot chamber 32 is defined by the second end surface 11b of the obturator 11, the second base surface 2c and the lateral surface 2a of the hollow element 2. The second pilot chamber 32 is in fluid communication with the communication chamber 30 through a small-diameter conduit 21. Elastic means 24 are arranged internally of the second pilot chamber 32, for example a helix spring arranged between the second end surface 11b of the obturator 11 and the second base surface 2c of the hollow element 2, which keep the obturator 11 in the first position thereof.

The valve operates as follows.

In the absence of commands to the electromechanical actuator 9, the stem 10 does not exert any force of the bearing 8 which is free to move from the outlet of the pilot channel 7. Internally of the pilot channel 7 and the first pilot chamber 31, therefore, the operator fluid pressure is the reservoir pressure, i.e. a “low” pressure. The obturator 11 is kept in the first position by the action of elastic means 24. In this condition the fluid coming from the positive-displacement pump passes through the inlet opening 4, penetrates into the internal channel 14 of the obturator 11, reaches the first pilot chamber 31, runs along the pilot channel 7, moves the bearing 8 from the outlet of the pilot channel 7, reaches the discharge chamber 40 and from there, passing through the secondary outlet openings 6a, reaches the reservoir.

In the presence of a command on the electromechanical actuator 9, the stem 10 exerts a force on the bearing 8, which bearing opposes passage of fluid by increasing the pressure in the pilot channel 7, in the first pilot chamber 31 and in the internal channel 14. The increase of pressure in the first pilot chamber 31 causes a force which overcomes the elastic means 24 and the pressure in the second pilot chamber 32 and pushes the obturator 11 towards the second position. During the displacement the obturator 11 closes the discharge openings 6 and, through the communication chamber 30, places the inlet openings 4 in communication with the outlet openings 5. The pressurized fluid thus reaches the hydraulic actuator. The obturator is kept in this position by the equilibrium between the pressure in the first pilot chamber 31 and the pressure in the second pilot chamber 32 plus the action of the force exerted by the elastic means 24. The pressure in the second pilot chamber 32, by dint of the small diameter conduit 21, is the same as the pressure in the communication chamber 40, i.e. the pressure in the hydraulic actuator. The small-diameter conduit 21 softens the pressure peaks which can occur internally of the communication chamber 40. The position of the obturator 11 can be regulated by modulating the signal sent to the electromechanical actuator 9. This has an influence on the force which is exerted on the bearing 8, and therefore on the pressure in the first pilot chamber 31. The regulation of the position of the obturator 11 enables the degree of aperture of the inlet opening 4 to be varied, i.e. the pressure in the communication chamber 30 can be varied, and thus so can the pressure of the fluid sent to the hydraulic actuator.

The valve of the present invention can be connected to a support element 100 by a screw 22 passing through a portion of the support element 100. The support element 100 can be for example a part of a machine on which the valve is mounted. The screw 22 inserts, at least at a terminal portion thereof, into an annular channel 23 afforded externally of the projecting cylindrical portion 50a of the container 50. Preferably the screw 22 is arranged radially of the projecting cylindrical portion 50a. The screw 22 must be tightened extremely precisely in order to avoid any kind of radial stress on the projecting cylindrical portion 50a which might be transmitted to the hollow body 2. Deformations in the hollow body 2, even of a small entity, might compromise optimum valve operation.

The valve of the present invention offers important advantages. Firstly, it is extremely stable and precise as, thanks to the conformation of the internal channel of the obturator, only a static pressure acts on the control bearing. A further advantage is that the valve is extremely simple and rapid to calibrate, as it is not necessary to dismount the valve in order to replace the stem acting on the control bearing. A further advantage is that fastening the valve to the support element does not require the use of special fastening elements, but only a screw.

1). An electromechanically-controlled proportional valve, of a cartridge type, insertable in a support element (100) and comprising a hollow body which is axial symmetric with respect to a longitudinal axis, which hollow body exhibits a lateral surface, a first base surface and a second base surface, a cylindrical internal cavity and which hollow body is radially provided, on the lateral surface, with a plurality of inlet openings, a plurality of outlet openings and a plurality of discharge openings;
wherein the inlet openings are predisposed for connecting the internal cavity with a pressurized fluid source, the outlet openings are predisposed for connection of the internal cavity with an actuator, and the discharge openings are predisposed for connection of the internal cavity with a reservoir;
wherein the hollow body further comprises a pilot channel afforded in the first base surface coaxially to the longitudinal axis, an end of the pilot channel being occludable by a bearing which is mobile in a parallel direction to the longitudinal axis;
wherein the pilot channel is predisposed to place the internal cavity in communication with a discharge chamber, which discharge chamber is annular and coaxial to the hollow body, and which discharge chamber is provided with secondary outlet openings connected to the reservoir;
comprising a cylindrical obturator which is sealedly slidable internally of the internal cavity coaxially to the longitudinal axis, which obturator exhibits an annular channel which defines a communication chamber with a surface of the internal channel;
wherein the obturator is mobile between a first position, in which the obturator places the outlet openings in communication with the discharge openings through the communication chamber, and a second position, in which the obturator places the outlet openings in communication with the inlet openings through the communication chamber;
wherein the obturator is provided with an internal channel predisposed to place the inlet openings in communication with the pilot channel when the obturator is in the first position;
comprising a container internally of which are arranged: an electromechanical actuator and a cylindrical element which is coaxial to the longitudinal axis; the cylindrical element having at an end thereof a cylindrical seating, coaxial to the longitudinal axis, along which the bearing can run;
wherein the cylindrical element comprises a through-hole which is coaxial to the longitudinal axis along which a stem can slide;
wherein the electromechanical actuator is predisposed to exert, on command, on the stem, a direct force along the longitudinal axis, which force pushes the bearing towards an end of the pilot channel;
wherein the hollow body is connected to the container in such a way that the hollow body at least partially projects into the container, the discharge chamber being defined between an inwardly-projecting portion of the hollow body and a projecting cylindrical portion of the container;
wherein the cylindrical element comprises an annular expansion predisposed to contact against a striker surface of the discharge chamber and prevent displacements of the cylindrical element in a direction which is parallel to the longitudinal axis and distancing from the hollow body;
wherein a terminal tract of the internal channel, which opens in proximity of an inlet of the pilot channel, exhibits a longitudinal axis which is different to the longitudinal axis, and therefore an end of the terminal tract is not facing an inlet of the pilot channel.

2). The valve of claim 1, wherein the terminal tract of the internal channel is afforded internally of an end element which is inserted in an end of the obturator located at a side comprising the pilot channel, the end element comprising an inlet tract which opens through a nozzle into the terminal tract.

3). The valve of claim 2, wherein the terminal tract is perpendicular to the longitudinal axis.

4). The valve of claim 1, wherein the hollow element is screwed to the container, elastic means being interpositioned between the cylindrical element and the hollow body.

5). The valve of claim 1, wherein the hollow seating is provided with radial through-holes which place the hollow seating in communication with the discharge chamber, at least two of the radial through-holes opening onto shaped portions of the cylindrical element, the shaped portions being located in diametrically opposite positions on the cylindrical element.

6). The valve of claim 1, wherein the valve is connectable to the support element by means of a screw passing through a portion of the support element, the screw inserting at least at a terminal end thereof in an annular channel made externally of the projecting portion of the container.
